(19) United States
(12) Patent Application Publication
(10) Pub. No.: US 2008/0106806 A1
(43) Pub. Date: May 8, 2008

(54) Optical Device with Fresnel Structure

(75) Inventors: Bernardus H.W. Hendriks, Eindhoven (NL); Emile J.K. Verstegen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,598

(22) PCT Filed: Aug. 22, 2005
(86) PCT No.: PCT/IB05/52749

§ 371 Date: Mar. 2, 2007

(30) Foreign Application Priority Data
Sep. 7, 2004 (EP) 04300581.8

(51) Int. Cl. G02B 3/08

(52) U.S. Cl. 359/742

(57) ABSTRACT

The invention relates to an optical device compris- 303 300 ing a Fresnel structure (101). The Fresnel structure is designed such that at least one phase jump is introduced in a radiation beam that 302 passes through said Fresnel structure. The optical device further comprises a stepped structure (102) for compensating for said phase jump.

### FIELD OF THE INVENTION

The present invention relates to an optical device comprising a Fresnel structure, in particular an optical device comprising a lens with variable focal length, said lens comprising a Fresnel structure.

The present invention is particularly relevant for an optical device in which a variable focal length is needed, for example a camera.

### BACKGROUND OF THE INVENTION

U.S. Pat. No. 4,904,063 describes a liquid crystal lens comprising a Fresnel structure in contact with a liquid crystal material which refractive index can be varied by application of a voltage. This allows varying the focal length of said liquid crystal lens. As explained in this patent, the use of a Fresnel lens instead of a conventional lens allows reducing the thickness of the liquid crystal material. This reduces the time needed for switching from one focal length to another, because the switching time of the liquid crystal material depends on its thickness.

A Fresnel lens is obtained from a conventional lens in that portions of the conventional lens are removed. Such a portion is chosen in such a way that the removal of said portion introduces a change of optical path in a radiation beam passing through the Fresnel lens, which change is a multiple of the wavelength of said radiation beam. In this way, the diffraction-limited performance of the conventional lens is maintained in the corresponding Fresnel lens. However, a Fresnel lens is only designed for a particular wavelength. As a consequence, it cannot be used in applications that use light with different wavelengths, such as natural light in a camera for instance.

### SUMMARY OF THE INVENTION

It is an object of the invention to provide an optical device that uses a Fresnel structure, which optical device is suitable for different wavelengths.

To this end, the invention proposes an optical device comprising a Fresnel structure designed such that at least one phase jump is introduced in a radiation beam that passes through said Fresnel structure, said optical device further comprising a stepped structure for compensating for said phase jump. A Fresnel structure comprises annular zones. Between two annular zones, a phase jump always occurs. For the design wavelength of the Fresnel structure, the phase jumps are multiple of 27, which means that the diffraction-limited performances of the conventional lens are not modified. However, for a wavelength that differs from the design wavelength of the Fresnel structure, the phase jumps are not multiple of 27c, and this creates strong aberrations in the radiation beam passing through the Fresnel structure. According to the invention, a stepped structure is used in the optical device for compensating for these phase jumps. This stepped structure is designed in such a way that it introduces phase changes that compensate for the phase jumps due to the Fresnel structure. As a consequence, the performances of the optical device does not depend on the wavelength of the radiation beam, and the optical device may be used with natural light for instance.

Advantageously, the Fresnel structure has a first refractive index and the stepped structure as a second, higher refractive index. When the Fresnel structure and the stepped structure have the same refractive index, the thickness of the steps of the stepped structure are the same as the thickness of the portions of the conventional lens that have been removed for designing the Fresnel lens. When choosing a higher refractive index for the stepped structure, the thickness of the steps of the stepped structure may be reduced, which is advantageous for the size of the optical device.

Although the reduction of the thickness of the conventional lens is now at least partly compensated by the thickness of the stepped structure, the invention is particularly advantageous, in particular in optical devices where the overall thickness is not important. The invention relates in particular to an optical device as described hereinbefore, which optical device further comprises a material in contact with said Fresnel structure, said material having a refractive index that can be varied by application of a voltage. In this optical device, only the thickness of said material has an importance, because the switching time is linked to said thickness. The addition of a stepped structure in the optical device does not modify the thickness of the material that is in contact with the Fresnel structure. Hence, the switching time remains the same as in the prior art, while the optical device can be used with natural light.

Advantageously, said Fresnel structure, said material and said stepped structure form part of one and the same cell. This simplifies the manufacturing process of the optical device, because there is no need to align the stepped structure with the Fresnel structure, as the stepped structure and the Fresnel structure are already aligned in said cell. Preferably, the optical device comprises:
a first Fresnel structure designed such that at least a first phase jump is introduced in a radiation beam that passes through said first Fresnel structure,
a second Fresnel structure designed such that at least a second phase jump is introduced in a radiation beam that passes through said second Fresnel structure,
a first birefringent material in contact with said first Fresnel structure, said first birefringent material having a first extraordinary axis,
a second birefringent material in contact with said second Fresnel structure, said second birefringent material having a second extraordinary axis perpendicular to said first extraordinary axis,
means for modifying the extraordinary refractive index of the first and the second birefringent material such that the extraordinary refractive indices of the first and the second birefringent material remain substantially equal, and
means for compensating for said first and second phase jumps.

The optical device comprises two birefringent materials which extraordinary axes are perpendicular. As will be explained in the detailed description, such a combination of two birefringent materials is polarization independent. This avoids use of polarizers in the optical device.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows an optical device in accordance with the invention;

FIGS. 2a and 2b show variants of an optical device in accordance with the invention;

FIGS. 3a, 3b, 3c and 3d show variable focal length devices in accordance with the invention;

FIGS. 4a and 4b show other variable focal length devices in accordance with the invention.

### DETAILED DESCRIPTION OF THE INVENTION

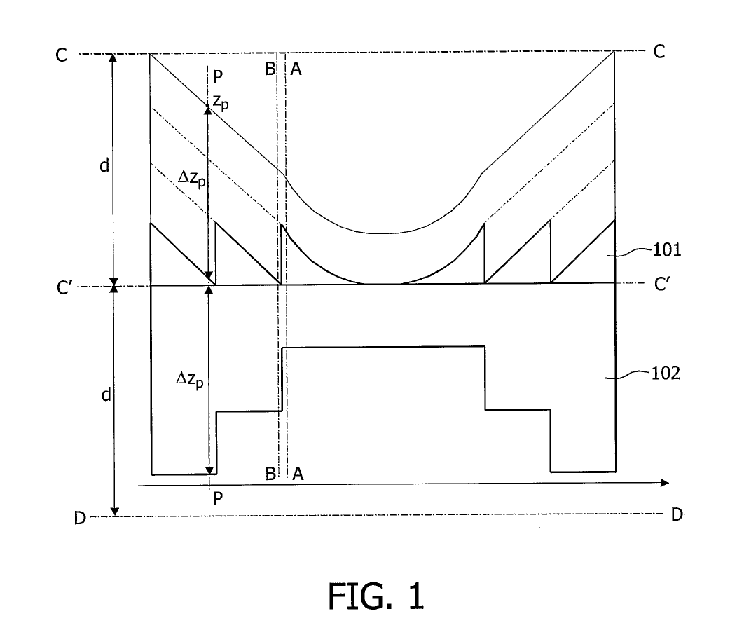

An optical device in accordance with the invention is depicted in FIG. 1. This optical device comprises a Fresnel structure 101 and a stepped structure 102. Fresnel structures are known to those skilled in the art. For example, a Fresnel lens is described in “Microscope objectives for optical disc systems”, by J.J.M. Braat in “Huygens' principle 1690-1990 theory and applications”, Proceedings of the international symposium, (The Hague/Scheveningen, 1990, Elsevier Science Publishers B.V.), Editors: H. Blok, H.A. Ferweda, H.K. Kuiken, Pages 33-63. In FIG. 1, the conventional lens from which the Fresnel structure 101 is made is shown in fine line and the Fresnel structure 101 and the stepped structure 102 are shown in thick lines. The portions of the conventional lens that have been removed for making the Fresnel structure 101 are shown in dotted line.

In FIG. 1, the Fresnel structure 101 and the stepped structure 102 are shown as distinct parts. However, the Fresnel structure 101 and the stepped structure 102 may form part of one and the same element, for example an optical element obtained by a moulding process.

The stepped structure 102 is designed as follows. The stepped structure comprises steps, which thicknesses are chosen equal to the thicknesses of the removed portions of the conventional lens from which the Fresnel structure has been designed. In a plane PP, the height of the surface of the conventional lens is noted zp. In this plane PP, a portion having a thickness Azp has been removed for designing the Fresnel structure 101. In this plane PP, the thickness of the stepped structure is chosen equal to Azp. In the following example, two planes AA and BB are defined on each side of a step of the Fresnel structure, with ZA nearly equal to Z_{b}

In the plane AA, the optical path length between planes CC and C° C′is:

W_{cc}(A)=d+(n-1)(ZA-AZA), where n is the refractive index of the Fresnel structure 101.

In the plane BB, the optical path length between planes CC and C° C′is:

WCC′(B)=d+(n−1)(Z_{B}-ΔZ_{B})

As a consequence, the Fresnel structure 101 introduces a jump of optical path length, which is:

W_{cc}′(A)-Wcc,(B)=(n-l)(AZB -AzA), because ZA=ZB

As explained in the above-mentioned publication, the design of the Fresnel structure is such that Azp=mpko/(n-1), where mp is an integer. As a consequence, the jump of optical path length is: WCC′(A)-WcC,(B)=(mB-mA)ko. This means that when a radiation beam having the design wavelength Xo passes through the Fresnel structure 101, this Fresnel structure 101 introduces a phase jump that is a multiple of 27c. Hence, no wavefront aberration is introduced. However, when a radiation beam having a wavelength kl different from ko passes through the Fresnel structure 101, this Fresnel structure 101 introduces a phase jump that is not a multiple of 2ic, and wavefront aberrations are thus introduced In the plane AA, the optical path length between planes C° C′and DD is:

Wc′D(A)-lzA+(d-AZA), where the refractive index of the stepped structure 102 is chosen equal to the refractive index n of the Fresnel structure 101.

In the plane BB, the optical path length between planes C° C′and DD is:

WC′D(B)=nAzB+(d-AzB) As a consequence, the difference of optical path length in planes AA and BB, between planes CC and DD is Wcc,(A)+Wc′D(A)-(Wcc,(B)+Wc′D(B))=0 This means that the stepped structure 102 compensates for the phase jump that is introduced by the Fresnel structure 101 between planes AA and BB. This does not depend on the wavelength of the radiation beam that passes through the optical device comprising the Fresnel structure 101 and the stepped structure 102. As a consequence, whatever the wavelength of the radiation beam, the wavefront aberrations that are introduced by the optical device in accordance with the invention are as low as the wavefront aberrations that are introduced by the conventional lens from which the Fresnel structure is designed. This means that the optical device in accordance with the invention may be used, for instance, with natural light.

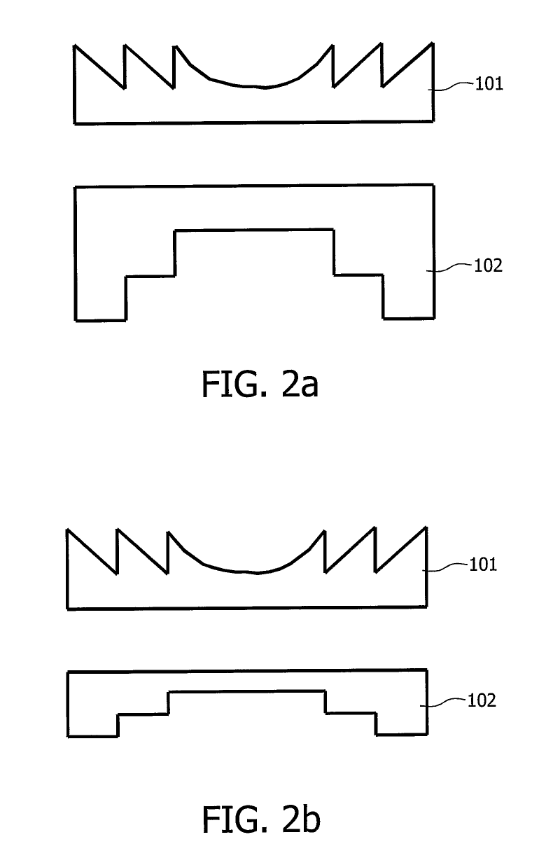

In FIG. 2a, a variant of the optical device in accordance with the invention is depicted. In this variant, the Fresnel structure 101 and the stepped structure 102 are distinct elements, which are not joined as in FIG. 1. Actually, the stepped structure 102 can be placed anywhere in the optical device, as soon as it is carefully aligned with the Fresnel structure 101 so as to compensate for the phase jumps introduced by the Fresnel structure 101.

In FIG. 2b, an advantageous variant of the optical device in accordance with the invention is depicted. The Fresnel structure 101 has a first refractive index and the stepped structure 102 as a second, higher refractive index. This renders possible to reduce the thickness of the steps of the stepped structure 102. If A′ZA and A′zB are the thickness of the steps of the stepped structure 102 of FIG. 2b in planes AA and BB of FIG. 1, the stepped structure 102 compensates for the phase jump introduced by the Fresnel structure 101 between planes AA and BB if : (A′ZB-A′zA)/(AzB-AzA)=(nl-l)/(n2-1), where ni is the refractive index of the Fresnel structure 101 and n₂ the refractive index of the stepped structure 102. For example, with nl=1.5 and n2=2, we find: (A′ZB-A′zA)=0.5(AzB-AzA). This means that in this case the thickness of the stepped structure 102 can be reduced by a factor 2. This is particularly advantageous, because the size of the optical device can thus be reduced.

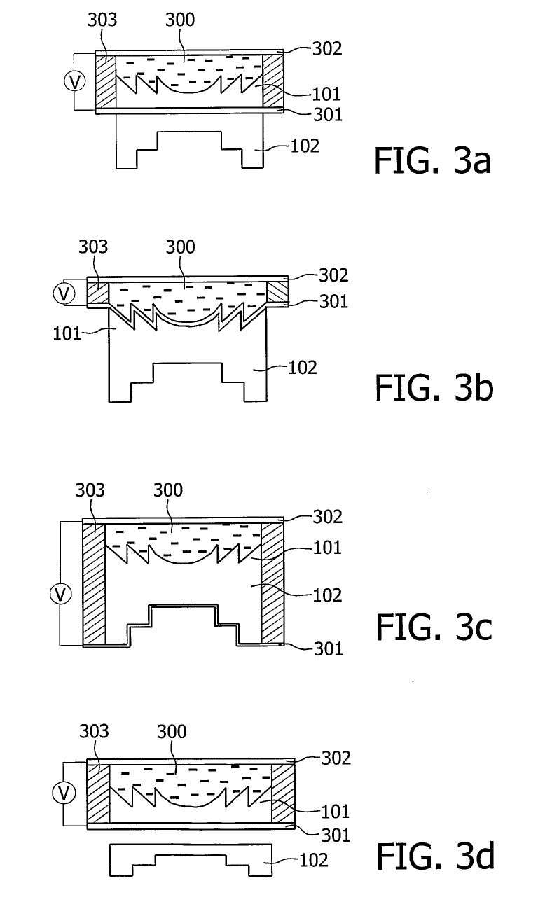

Optical devices in accordance with the invention, having a variable focal length, are depicted in FIGS. 3a to 3d. Such an optical device comprises the Fresnel structure 101, the 2749 stepped structure 102, a liquid crystal material 300, a first electrode 301, a second electrode 302 and an insulator spacer 303. The functioning of such an optical device is the functioning of a Fresnel liquid crystal lens, such as described in patent US 4,904,063. However, the optical devices of FIGS. 3a to 3d comprise a stepped structure such as described in FIGS. 1 and 2, such that these optical devices can be used with different wavelengths, for instance with natural light.

The liquid crystal material is in contact with the Fresnel structure 101. It should be noted that in FIG. 3b, the Fresnel structure 101 comprises the first electrode 301, such that the liquid crystal material is also in contact with the Fresnel structure 101 in this case.

The stepped structure 102 increases the overall thickness of the optical devices of FIGS. 3a to 3d, compared with the optical device of US 4,904,063. However, this has no importance, because the thickness of the liquid crystal material 300 is not increased, compared with US 4,904,063. Hence, the switching time of these optical devices is not increased.

In FIGS. 3a to 3c, the Fresnel structure 101, the liquid crystal material 300 and the stepped structure 102 form part of one and the same cell. This is particularly advantageous, because the Fresnel structure 101 is automatically aligned with the stepped structure 102, which is not the case in the optical device of FIG. 3d, where the stepped structure 102 needs to be aligned with the Fresnel structure 101. In FIG. 3d, the stepped structure 102 is separated from the Fresnel structure 101 and the liquid crystal material 300. This may be advantageous, because in this case the stepped structure 102 may be integrated in another optical component of the optical device, such as a lens or a grating.

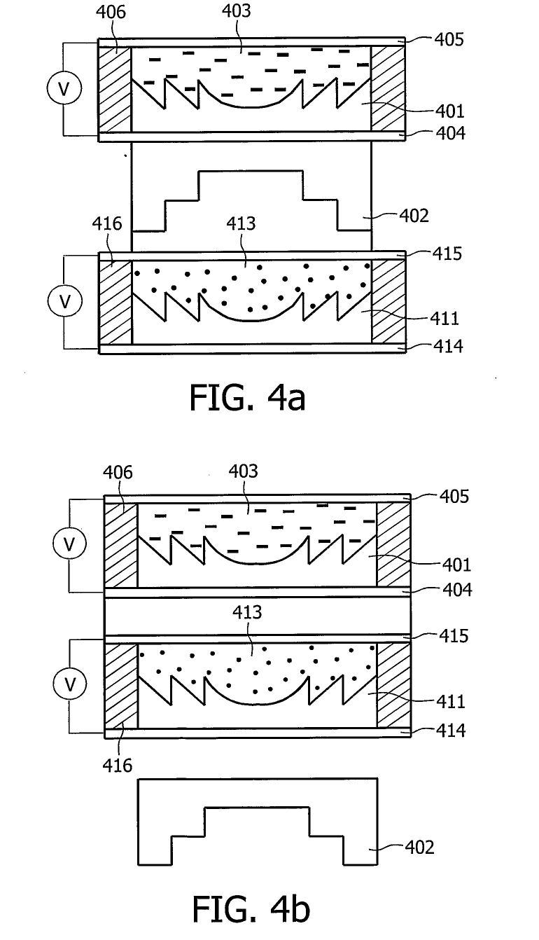

In FIG. 4a, a variable focal length device in accordance with the invention is described, which is polarization independent. It comprises a first Fresnel structure 401, a stepped structure 402, a first liquid crystal material 403, a first electrode 404, a second electrode 405, a first insulator spacer 406, a second Fresnel structure 411, a second liquid crystal material 413, a third electrode 414, a fourth electrode 415 and a second insulator spacer 416. The first Fresnel structure 401 introduces at least a first phase jump in a radiation beam that passes through said first Fresnel structure 401 and the second Fresnel structure 411 introduces at least a second phase jump in a radiation beam that passes through said second Fresnel structure 411. The first and second Fresnel structures 401 and 411 are similar, such that the first and second phase jumps are similar. The stepped structure 402 is designed for compensating for the first phase jump and the second phase jump, as explained hereinafter. WO 2006/027710 PCT/IB2005/052749

The optical device of FIG. 4b comprises the same elements, but the stepped structure 412 is separated from the cell comprising the first and second Fresnel structures 401 and 411 in contact with the first and second liquid crystal materials 403 and 413.

In the examples of FIGS. 3a to 4b, a liquid crystal material is used. However, other birefringent materials may be used in accordance with the invention. For example, molecules comprising a charged substituent which can be rotated when subjected to a current created by a potential difference applied between two electrodes may be used.

The first liquid crystal material 403 in contact with the first Fresnel structure 401 has a first extraordinary axis and the second liquid crystal material 413 in contact with the second Fresnel structure 41 Ihas a second extraordinary axis perpendicular to said first extraordinary axis. This may be achieved in that a suitable anisotropic network is used for the first and second liquid crystal materials 403 and 413. Alternatively, a chemical or mechanical modification of the electrodes 405 and 415 in contact with the liquid crystal materials 403 and 413 may be performed, in order to induce a preferred orientation of the liquid crystal alignment.

When a light beam having a polarization parallel to the second extraordinary axis passes through the optical device shown in FIG. 4a or 4b, the first Fresnel structure 401 acts as a transparent plate. This means that only the second Fresnel structure 411 acts on said radiation beam. When a light beam having a polarization perpendicular to the second extraordinary axis passes through the optical device shown in FIG. 4a or 4b, the second Fresnel structure 411 acts as a transparent plate. This means that only the first Fresnel structure 401 acts on said radiation beam. If the first and second Fresnel structures 401 and 411 are similar structures, the action of the optical device on the light beam having a polarization parallel to the second extraordinary axis is the same as the action of the optical device on the light beam having a polarization perpendicular to the second extraordinary axis. In other words, the behavior of the optical device of FIG. 4a or 4b does not depend on the polarization of the light beam that passes through said optical device.

When a light beam having a polarization parallel to the second extraordinary axis passes through the optical device shown in FIG. 4a or 4b, only the second Fresnel structure 411 introduces phase jumps. When a light beam having a polarization perpendicular to the second extraordinary axis passes through the optical device shown in FIG. 4a or 4b, only the first Fresnel structure 401 introduces phase jumps. As a consequence, the stepped structure 402 only needs to compensate for either the first or the second phase jump. As these phase WO 2006/027710 PCT/IB2005/052749 jumps are similar, the stepped structure is designed as described in FIGS. 1 to 3d, although the devices of FIGS. 4a to 4b comprise two Fresnel structures 401 and 411.

In order to vary the optical properties of this optical device, the extraordinary refractive index of the first and second liquid crystal materials 403 and 413 are modified. In order to keep the optical device polarization independent, the means for modifying the extraordinary refractive index of the first and the second liquid crystal materials should be designed such that the extraordinary refractive indices of the first and the second liquid crystal material remain substantially equal. This can be simply achieved in that the same potential difference is applied between the first and second electrodes 404 and 405, and the third and fourth electrodes 414 and 415, respectively.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical device comprising a Fresnel structure (101) designed such that at least one phase jump is introduced in a radiation beam that passes through said Fresnel structure, said optical device further comprising a stepped structure (102) for compensating for said phase jump.

2. An optical device as claimed in claim 1, wherein said Fresnel structure has a first refractive index and said stepped structure as a second, higher refractive index.

3. An optical device as claimed in claim 1, said optical device further comprising a material (300) in contact with said Fresnel structure, said material having a refractive index that can be varied by application of a voltage.

4. An optical device as claimed in claim 3, wherein said Fresnel structure, said material and said stepped structure form part of one and the same cell.

5. An optical device as claimed in claim 3, said optical device comprising
a first Fresnel structure (401) designed such that at least a first phase jump is introduced in a radiation beam that passes through said first Fresnel structure,
a second Fresnel structure (411) designed such that at least a second phase jump is introduced in a radiation beam that passes through said second Fresnel structure,
a first birefringent material (403) in contact with said first Fresnel structure, said first birefringent material having a first extraordinary axis,
a second birefringent material (413) in contact with said second Fresnel structure, said second birefringent material having a second extraordinary axis perpendicular to said first extraordinary axis,
means for modifying the extraordinary refractive index of the first and the second birefringent material such that the extraordinary refractive indices of the first and the second birefringent material remain substantially equal, and
means (411, 412, 420) for compensating for said first and second phase jumps.
